(19) United States
(12) Patent Application Publication
(10) Pub. No.: US 2025/0132464 A1
(43) Pub. Date: Apr. 24, 2025

(54) SEPARATOR AND BATTERY

(71) Applicant: ZHUHAI COSMX BATTERY CO., LTD., Zhuhai (CN)

(72) Inventors: Yang YANG, Zhuhai (CN); Fei HE, Zhuhai (CN)

(73) Assignee: ZHUHAI COSMX BATTERY CO., LTD., Zhuhai (CN)

(21) Appl. No.: 18/922,278

(22) Filed: Oct. 21, 2024

(30) Foreign Application Priority Data
Oct. 23, 2023 (CN) 202311376098.6

(51) Int. Cl. H01M 50/491; H01M 50/403; H01M 50/417; H01M 50/431; H01M 50/451; H01M 50/497

(52) U.S. Cl. CPC H01M 50/491; H01M 50/403; H01M 50/417; H01M 50/431; H01M 50/451; H01M 50/497

(57) ABSTRACT

Disclosed are a separator and a battery including the separator. The separator includes a base material layer and a first coating layer, the base material layer has a porous structure, the porous structure has pores, the first coating layer is located on inner walls of the pores, the first coating layer includes a first lithium-containing compound, and a ratio of a thickness of the first coating layer to a pore diameter of the pores ranges from 1:4 to 1:500. The separator in the present disclosure has good electrolyte solution infiltration and an excellent ion conductivity. The battery including the separator in the present disclosure has excellent performance during high-rate charge and discharge and low-temperature and high-temperature charge and discharge.

### CROSS-REFERENCE TO RELATED APPLICATIONS

The present disclosure claims priority to Chinese Patent Application No. 202311376098.6, filed on Oct. 23, 2023, which is hereby incorporated by reference in its entirety.

### TECHNICAL FIELD

The present disclosure relates to the field of batteries, and specifically relates to a separator and a battery including the separator.

### BACKGROUND

Lithium-ion batteries have advantages such as a high capacity and a high open circuit voltage, and are widely used in 3 C products, electric vehicles, and the like. A fast charging capability is crucial to improving commercial competitiveness of lithium-ion battery products. One of the main factors limiting fast charging of lithium-ion batteries is a speed at which lithium ions are transported in an electrolyte.

A separator is a porous film material with electron insulation properties. The separator plays two basic roles in lithium-ion batteries: electron insulation and ion conduction. During charging of a lithium-ion battery, lithium ions are deintercalated from a positive electrode material, pass through pores of the separator through an electrolyte solution, and reach and are intercalated into a negative electrode material. In contrast, during discharging, lithium ions are deintercalated from the negative electrode material, pass through pores of the separator through the electrolyte solution, and reach and are intercalated into the positive electrode material. Due to lyophobic surfaces and low surface energy of conventional separator materials, such a separator has poor electrolyte solution infiltration and a weak ion conductivity, which in turn affects rate performance of the battery.

Therefore, it is necessary to develop a separator having a strong ion conductivity.

### SUMMARY

The objective of the present disclosure is to overcome the problem of a weak ion conductivity of a separator in the prior art by providing a separator and a battery including the separator. The separator in the present disclosure has good electrolyte solution infiltration and an excellent ion conductivity. The battery including the separator in the present disclosure has excellent performance during high-rate charge and discharge.

A first aspect of the present disclosure provides a separator. The separator includes a base material layer and a first coating layer, the base material layer has a porous structure, the porous structure has pores, the first coating layer is located on inner walls of the pores, the first coating layer includes a first lithium-containing compound, and a ratio of a thickness of the first coating layer to a pore diameter of the pores ranges from 1:4 to 1:500.

A second aspect of the present disclosure provides a method for preparing the separator according to the first aspect of the present disclosure. The method includes at least the following steps:
(A1) introducing a first precursor into a base material layer at a first heating temperature to perform a first reaction, and introducing a first inert atmosphere to perform a first purge;
(A2) introducing a second precursor at a second heating temperature to perform a second reaction, and introducing a second inert atmosphere to perform a second purge;
optionally, (A3) introducing a third precursor at a third heating temperature to perform a third reaction, and introducing a third inert atmosphere to perform a third purge; and
(A4) repeating the foregoing steps (A1) and (A2) or (A1) to (A3) 1 time to 500 times, where the base material layer includes a modified matrix or an unmodified matrix, and the matrix includes at least one of polyethylene, polyvinyl chloride, polyoxyethylene, polypropylene, nylon, glass fiber, polyethylene terephthalate, polyimide, aramid, cellulose, or nonwoven fabric; the first precursor includes at least one of methyllithium, n-butyllithium, tert-butyllithium, lithium tert-butoxide, phenyllithium, or dialkyl copper lithium; the second precursor includes at least one of the following gases: water vapor, CO₂, HF, HCl, HBr, HI, N₂, or O₂; and the third precursor includes at least one of the following gases: PF₅, N₂, trimethylboron, O₂, or O₃.

A third aspect of the present disclosure provides a battery. The battery includes the separator according to the first aspect of the present disclosure and/or the separator prepared by using the method according to the second aspect of the present disclosure.

Based on the foregoing technical solutions, the present disclosure has at least the following advantages over the conventional technology.

Firstly, a coating layer is disposed on an inner wall of a pore in a base material layer of a separator of the present disclosure, and a ratio of a thickness of the coating layer to a pore diameter of the pore is within a specific range, which significantly improves electrolyte solution infiltration of the separator, greatly improves an ion conductivity of the separator, and can significantly reduce a transportation resistance of lithium ions during charge and discharge of a battery, thereby allowing the battery to exhibit high performance during high-rate charge and discharge and low-temperature and high-temperature charge and discharge.

Secondly, a separator prepared by using a method in the present disclosure has excellent step coverage and may generate an excellent three-dimensional conformal coating layer.

An endpoint and any value of the ranges disclosed herein are not limited to the exact ranges or values, and these ranges or values shall be understood to include values close to these ranges or values. For a numerical range, one or more new numerical ranges may be obtained in combination with each other between endpoint values of respective ranges, between endpoint values of respective ranges and individual point values, and between individual point values, and these numerical range should be considered as specifically disclosed herein.

### BRIEF DESCRIPTION OF THE DRAWINGS

FIG. 1 is a scanning electron microscope (SEM) image of a separator according to an example of the present disclosure.

FIG. 2 is an SEM image of a cross section of a separator prepared in Example 1 before deposition of a first coating layer and a second coating layer.

FIG. 3 is an SEM image of a cross section of a separator prepared in Example 1 after deposition of a first coating layer and a second coating layer.

### DETAILED DESCRIPTION OF THE EMBODIMENTS

Specific implementations of the present disclosure are described below in detail. It should be understood that the specific implementations described herein are merely used for the purposes of illustrating and explaining the present disclosure, rather than limiting the present disclosure.

A first aspect of the present disclosure provides a separator. The separator may include a base material layer and a first coating layer, the base material layer may have a porous structure, the porous structure has pores, the first coating layer may be located on inner walls of the pores, the first coating layer may include a first lithium-containing compound, and a ratio of a thickness of the first coating layer to a pore diameter of the pores may range from 1:4 to 1:500, for example, is 1:4, 1:5, 1:10, 1:20, 1:30, 1:40, 1:50, 1:60, 1:70, 1:80, 1:90, 1:100, 1:200, 1:300, 1:400, or 1:500.

In the present disclosure, “a pore diameter of the pores” is the pore diameter of the pores in the base material layer, and the pore diameter is not a pore diameter used after the first coating layer is disposed.

In the present disclosure, the thickness of the first coating layer refers to a distance of the first coating layer in a direction from an inner wall of the pore to the center of the pore (that is, a dimension in a pore diameter direction). The thickness of the first coating layer may be measured by using conventional methods in the art, for example, by using SEM.

In the present disclosure, the pore diameter of the pores may be measured by using conventional methods in the art, for example, by using a gas permeability pore diameter tester to measure the base material layer, and an average pore diameter obtained is the pore diameter of the pores; or the separator is measured, and an average pore diameter obtained minus the thickness of the first coating layer is the pore diameter of the pores; or the separator is measured after removing a second coating layer, and an average pore diameter obtained minus the thickness of the first coating layer is the pore diameter of the pores.

The separator plays two basic roles in a battery: electron insulation and ion conduction. However, conventional separator materials (such as polyethylene films) have poor electrolyte solution infiltration due to lyophobic surfaces and low surface energy of the separator materials. The inventors of the present disclosure find that modifying the conventional separator materials (that is, disposing a coating layer on a separator material) can improve electrolyte solution infiltration and retention of the separator, thereby improving dynamic performance of the separator. Furthermore, the inventors of the present disclosure find that commonly used separator materials generally have a porous structure, and if a ratio of a thickness of a coating layer disposed on the inner walls of the pores of the porous structure to the pore diameter of the pores of the porous structure is within a specific range, ion conduction pores cannot be blocked, and an ion conductivity of the separator can be improved, thereby further improving the dynamic performance of the separator.

In an example, the ratio of the thickness of the first coating layer to the pore diameter of the pores ranges from 1:8 to 1:400.

In an example, the ratio of the thickness of the first coating layer to the pore diameter of the pores ranges from 1:10 to 1:40.

In the present disclosure, the pore diameter of the pores may range from 10 nm to 1000 nm, for example, is 10 nm, 20 nm, 30 nm, 40 nm, 50 nm, 60 nm, 70 nm, 80 nm, 90 nm, 100 nm, 110 nm, 120 nm, 130 nm, 140 nm, 150 nm, 160 nm, 170 nm, 180 nm, 190 nm, 200 nm, 300 nm, 400 nm, 500 nm, 600 nm, 700 nm, 800 nm, 900 nm, or 1000 nm.

In an example, the pore diameter of the pores ranges from 20 nm to 85 nm.

The inventors of the present disclosure find that when the thickness of the first coating layer is within a specific range, the electrolyte solution infiltration of the separator is improved, the surface energy of the separator is increased, and an ion conductivity of the separator is significantly improved, while ensuring a porosity of the base material layer of the separator.

In the present disclosure, the thickness of the first coating layer may range from 0.01 nm to 200 nm, for example, is 0.01 nm, 0.05 nm, 0.1 nm, 0.5 nm, 1 nm, 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 150 nm, or 200 nm.

In an example, the thickness of the first coating layer ranges from 0.05 nm to 10 nm.

In an example, the thickness of the first coating layer ranges from 1 nm to 4 nm.

In the present disclosure, the separator may further include a second coating layer, and the second coating layer may be located on a surface of either or both sides of the base material layer.

In an example, the separator includes the base material layer, the first coating layer, and the second coating layer, the base material layer has a porous structure, the porous structure has pores, the first coating layer is located on inner walls of the pores, the second coating layer is located on a surface of either or both sides of the base material layer, and the first coating layer and the second coating layer are disposed in contact with each other.

In the present disclosure, the thickness of the first coating layer may be equal to a thickness of the second coating layer, may be less than a thickness of the second coating layer, or may be greater than a thickness of the second coating layer.

In an example, the thickness of the first coating layer is equal to the thickness of the second coating layer.

In the present disclosure, the thickness of the second coating layer may range from 0.01 nm to 200 nm, for example, is 0.01 nm, 0.05 nm, 0.1 nm, 0.5 nm, 1 nm, 5 nm, 10 nm, 15 nm, 20 nm, 25 nm, 30 nm, 35 nm, 40 nm, 45 nm, 50 nm, 55 nm, 60 nm, 65 nm, 70 nm, 75 nm, 80 nm, 85 nm, 90 nm, 95 nm, 100 nm, 150 nm, or 200 nm.

In an example, the thickness of the second coating layer ranges from 0.05 nm to 10 nm.

In an example, the thickness of the second coating layer ranges from 1 nm to 4 nm.

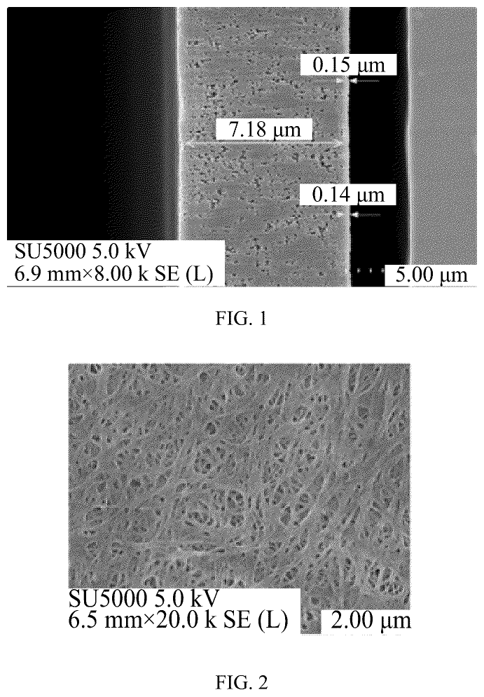

In the present disclosure, the thickness of the second coating layer is a single-layer thickness of the second coating layer, and the single-layer thickness is a thickness of the second coating layer located on a surface of either side of the base material layer. The thickness of the second coating layer may be measured by using conventional methods in the art, for example, by using SEM. FIG. 1 is an SEM image of a separator according to an example of the present disclosure. From the image, it may be measured that the thickness of the second coating layer ranges from 0.14 μm to 0.15 μm.

In the present disclosure, the second coating layer may include a second lithium-containing compound.

In the present disclosure, the first coating layer and the second coating layer may be obtained by using an atomic layer deposition (ALD) technology.

In the present disclosure, the porosity of the base material layer may range from 10% to 60%, for example, is 10%, 15%, 20%, 25%, 30%, 35%, 40%, 45%, 50%, 55%, or 60%.

In the present disclosure, the porosity of the base material layer may be measured by using a gas replacement method, and a calculation formula is as follows: Porosity=(V−V0)/V×100%, where V0 is an actual volume of the base material layer, V is a total volume of the base material layer, and V−V0 is a pore volume.

In the present disclosure, the base material layer may include a modified matrix or an unmodified matrix, and the matrix may include at least one of polyethylene, polyvinyl chloride, polyoxyethylene, polypropylene, nylon, glass fiber, polyethylene terephthalate (PET), polyimide (PI), aramid, cellulose, or nonwoven fabric.

In an example, the matrix includes at least one of polyethylene or polypropylene.

In an example, the matrix includes polyethylene.

In the present disclosure, the modification has a conventional meaning in the art, and the modification is generally considered to refer to a method for changing morphology or properties of a material by physical and/or chemical means. In the present disclosure, the modification may include graft copolymerization modification (that is, grafting a polymer segment having a chemical structure different from that of a main chain onto the polymer main chain of the matrix).

The inventors of the present disclosure find that specific modification means may increase binding sites of the first coating layer and the second coating layer without destroying a pore structure of the matrix, so that the base material layer can be more tightly bound to the first coating layer and the second coating layer, thereby reducing a resistance of ions traveling through micropores of the separator, thereby allowing the battery to exhibit high performance during high-rate charge and discharge and low-temperature and high-temperature charge and discharge.

In an example, the modification is graft copolymerization modification.

In the present disclosure, a monomer for the graft copolymerization modification may include an ester.

In an example, a monomer for the graft copolymerization modification includes at least one of methyl methacrylate (MMA), methyl acrylate, propyl methacrylate, butyl methacrylate, or glycerol methacrylate.

In an example, a monomer for the graft copolymerization modification includes methyl methacrylate.

In the present disclosure, the base material layer may include the matrix modified by graft copolymerization, and a mass of the monomer grafted onto the matrix accounts for 0.1% to 20% of a total mass of the base material layer, for example, is 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, or 20%.

The inventors of the present disclosure find that when a ratio of the mass of the monomer grafted onto the matrix to the total mass of the base material layer is within a specific range, a thickness of the separator and uniformity of an ALD reaction can be effectively controlled.

In an example, the mass of the monomer grafted onto the matrix accounts for 2% to 8% of the total mass of the base material layer.

In the present disclosure, the “mass of the monomer grafted onto the matrix” may be measured by using conventional methods in the art. For example, a mass of the matrix before the reaction is W1, a mass of the base material layer after the graft reaction is W2, and a mass of the grafted monomer is W2−W1. For another example, the mass of the monomer grafted onto the matrix is measured by using the following method. Description is made by using an example in which methyl methacrylate is the monomer for the graft copolymerization modification. Details are as follows.

(1) The separator is cleaned with ethanol three to five times, placed in an oven at 65° C. to dry for 1 hour, and then weighed, to obtain a weight denoted as M1.

(2) The separator obtained in Step (1) is placed in an esterification bottle, a sodium hydroxide-ethanol solution of 100 ml (with a concentration of sodium hydroxide of 0.5 mol/L) is added, a reflux condenser is attached to the top of the esterification bottle, the esterification bottle is heated to reflux in a 70° C. water bath for 2 hours, and cooled to room temperature, and then a liquid in the esterification bottle is taken.

(3) Three to five drops of phenolphthalein are added to the liquid in the esterification bottle obtained in Step (2), the solution is titrated with a hydrochloric acid standard solution (with a concentration of 0.5 mol/L) until the pink color of the solution just fades, and a volume V1 (unit: ml) of the hydrochloric acid standard solution used is recorded.

(4) An amount of substance of the ester in the separator is calculated: N1 (unit: mol)=(100−V1)×0.5/1000, and the mass of the grafted monomer is M2=N1×100.12. The mass of the monomer grafted onto the matrix accounts for M2/M1 of the total mass of the base material layer.

In an example, the base material layer includes polyethylene modified by graft copolymerization of methyl methacrylate.

In an example, the base material layer includes polyethylene modified by graft copolymerization of methyl methacrylate, where a mass of methyl methacrylate grafted onto polyethylene accounts for 2% to 8% of the total mass of the base material layer.

In the present disclosure, the lithium-containing compound has a conventional meaning in the art, and the lithium-containing compound is generally considered to refer to a compound containing an element Li. In the present disclosure, the first lithium-containing compound and the second lithium-containing compound may each independently include a lithium salt, and the lithium salt may be a conventional lithium salt in the art.

In the present disclosure, the first lithium-containing compound and the second lithium-containing compound may be the same or different.

In an example, the first lithium-containing compound and the second lithium-containing compound are the same.

The inventors of the present disclosure find that the first lithium-containing compound and the second lithium-containing compound used in the present disclosure are selected from conventional lithium salts in battery electrolyte solutions, and application thereof in the separator may not have an adverse effect on the battery.

In an example, the first lithium-containing compound and the second lithium-containing compound each independently include at least one of lithium carbonate, lithium halide (for example, lithium chloride), lithium hexafluorophosphate, or lithium borate.

In an example, the first lithium-containing compound and the second lithium-containing compound include at least lithium carbonate.

The inventors of the present disclosure find that when contents of lithium carbonate in the first lithium-containing compound and the second lithium-containing compound are within a specific range, the battery including the separator has more excellent cycling stability.

In an example, a mass percentage of lithium carbonate in the first lithium-containing compound ranges from 40% to 100%.

In an example, a mass percentage of lithium carbonate in the second lithium-containing compound ranges from 40% to 100%.

In the present disclosure, the thickness of the separator may range from 3 μm to 16 μm, for example, is 3 μm, 4 μm, 5 μm, 6 μm, 7 μm, 8 μm, 9 μm, 10 μm, 11 μm, 12 μm, 13 μm, 14 μm, 15 μm, or 16 μm.

In an example, the thickness of the separator ranges from 5 μm to 9 μm.

In the present disclosure, an ionic conductivity of the separator may range from 1 S/cm to 40 S/cm, for example, is 1 S/cm, 2 S/cm, 3 S/cm, 4 S/cm, 5 S/cm, 6 S/cm, 7 S/cm, 8 S/cm, 9 S/cm, 10 S/cm, 11 S/cm, 12 S/cm, 13 S/cm, 14 S/cm, 15 S/cm, 16 S/cm, 17 S/cm, 18 S/cm, 19 S/cm, 20 S/cm, 21 S/cm, 22 S/cm, 23 S/cm, 24 S/cm, 25 S/cm, 26 S/cm, 27 S/cm, 28 S/cm, 29 S/cm, 30 S/cm, 31 S/cm, 32 S/cm, 33 S/cm, 34 S/cm, 35 S/cm, 36 S/cm, 37 S/cm, 38 S/cm, 39 S/cm, or 40 S/cm.

In an example, the ionic conductivity of the separator ranges from 1 S/cm to 30 S/cm.

In the present disclosure, the ionic conductivity of the separator may be measured according to provisions in GB/T 36363-2018.

The separator in the present disclosure can have improved electrolyte solution infiltration and retention, an improved ion conductivity, and excellent dynamic performance. The battery including the separator in the present disclosure has excellent performance during high-rate charge and discharge and low-temperature and high-temperature charge and discharge.

A second aspect of the present disclosure provides a method for preparing the separator according to the first aspect of the present disclosure. The method includes at least the following steps:
(A1) introducing a first precursor into a base material layer at a first heating temperature to perform a first reaction, and introducing a first inert atmosphere to perform a first purge;
(A2) introducing a second precursor at a second heating temperature to perform a second reaction, and introducing a second inert atmosphere to perform a second purge;
optionally, (A3) introducing a third precursor at a third heating temperature to perform a third reaction, and introducing a third inert atmosphere to perform a third purge; and
(A4) repeating the foregoing steps (A1) and (A2) or (A1) to (A3) 1 time to 500 times.

Specific selection and amounts of the materials used are described above, and details are not described herein again.

The atomic layer deposition (ALD) technology is an atomic-level thin film preparation technology. The inventors of the present disclosure find that a separator coating layer having a controllable thickness and being uniform can be prepared by using the ALD technology.

In the present disclosure, the foregoing preparation method may be performed on an atomic layer deposition instrument.

In the present disclosure, in Step (A1), after the first precursor is introduced, the first precursor is chemically adsorbed on the base material layer. A purpose of introducing the first inert atmosphere to perform the first purge is to clean and remove excess first precursor and reaction by-products.

In the present disclosure, in Step (A1), the first heating temperature may range from 45° C. to 70° C., for example, is 45° C., 50° C., 55° C., 60° C., 65° C., or 70° C.

In an example, in Step (A1), the first heating temperature ranges from 50° C. to 60° C.

In the present disclosure, in Step (A1), vacuuming and heating to the first heating temperature may be further included.

In the present disclosure, in Step (A1), the first precursor may include at least one of methyllithium, n-butyllithium, tert-butyllithium, lithium tert-butoxide, phenyllithium, or dialkyl copper lithium.

In the present disclosure, in Step (A1), duration of the first reaction may range from 10 s to 60 s, for example, is 10 s, 20 s, 30 s, 40 s, 50 s, or 60 s.

In the present disclosure, in Step (A1), the first inert atmosphere may include a conventional inert atmosphere in the art, for example, includes nitrogen.

In the present disclosure, in Step (A1), duration of the first purge ranges from 20 s to 40 s, for example, is 20 s, 25 s, 30 s, 35 s, or 40 s.

In the present disclosure, in Step (A2), after the second precursor is introduced, the second precursor reacts with the first precursor adsorbed on the base material layer.

In the present disclosure, in Step (A2), the second heating temperature may range from 45° C. to 70° C., for example, is 45° C., 50° C., 55° C., 60° C., 65° C., or 70° C.

In an example, in Step (A2), the second heating temperature ranges from 50° C. to 60° C.

In the present disclosure, in Step (A2), vacuuming and heating to the second heating temperature may be further included.

In the present disclosure, in Step (A2), the second precursor may include at least one of the following gases: water vapor, CO₂, HF, HCl, HBr, HI, N₂, or O₂.

In the present disclosure, in Step (A2), duration of the second reaction may range from 10 s to 70 s, for example, is 10 s, 20 s, 30 s, 40 s, 50 s, 60 s, or 70 s.

In the present disclosure, in Step (A2), the second inert atmosphere may include a conventional inert atmosphere in the art, for example, includes nitrogen.

In the present disclosure, in Step (A2), duration of the second purge ranges from 30 s to 60 s, for example, is 30 s, 35 s, 40 s, 45 s, 50 s, 55 s, or 60 s.

In the present disclosure, in Step (A3), the third heating temperature may range from 45° C. to 70° C., for example, is 45° C., 50° C., 55° C., 60° C., 65° C., or 70° C.

In an example, in Step (A3), the third heating temperature ranges from 50° C. to 60° C.

In the present disclosure, in Step (A3), vacuuming and heating to the third heating temperature may be further included.

In the present disclosure, in Step (A3), the third precursor may include at least one of the following gases: PF₅, N₂, trimethylboron, O₂, or O₃.

In the present disclosure, in Step (A3), duration of the third reaction may range from 10 s to 60 s, for example, is 10 s, 20 s, 30 s, 40 s, 50 s, or 60 s.

In the present disclosure, in Step (A3), the third inert atmosphere may include a conventional inert atmosphere in the art, for example, includes nitrogen.

In the present disclosure, in Step (A3), duration of the third purge ranges from 60 s to 90 s, for example, is 60 s, 70 s, 80 s, or 90 s.

In the present disclosure, in Step (A4), a quantity of repetitions may range from 1 to 500, for example, is 1, 5, 10, 20, 30, 40, 50, 60, 70, 80, 90, 100, 200, 300, 400, or 500.

In an example, in Step (A4), a quantity of repetitions may range from 20 to 50.

In the present disclosure, depending on the lithium-containing compound, the method may include Step (A1), Step (A2), and Step (A4), or may include Step (A1) to Step (A4).

In the present disclosure, the thickness of the first coating layer and the thickness of the second coating layer may be determined by the quantity of repetitions in Step (A4). In an example, in a case of one repetition, the second coating layer deposited by the ALD technology has a thickness of about 0.3 nm. For example, for the separator shown in FIG. 1, there are 500 repetitions in Step (A4), and the second coating layer deposited has a thickness ranging from 140 nm to 150 nm.

It may be understood that whether the method includes Step (A3) and differences in the heating temperatures, the precursors, duration of the reactions, and duration of the purges in Step (A1) to Step (A3) affect the thickness of the first coating layer and the thickness of the second coating layer that are obtained by one repetition. Therefore, the thicknesses of the coating layers may be controlled by adjusting the heating temperatures, the precursors, and duration of the purges. For example, in the case of one repetition, the separator shown in FIG. 1 has a first coating layer and a second coating layer having a thickness of about 0.3 nm, and the preparation method the first coating layer and the second coating layer is as follows:

The base material layer (polyethylene modified by graft copolymerization of methyl methacrylate) is placed on an atomic layer deposition instrument, and vacuuming and heating to 60° C. are performed; the first precursor (methyllithium) is introduced for chemical adsorption, the duration of the first reaction is 60 s, and the first inert atmosphere (nitrogen) is introduced to perform the first purge for 40 s; the second precursor (a mixture of water vapor and CO₂) is reacted with the first precursor, the duration of the second reaction is 70 s, and the second inert atmosphere (nitrogen) is introduced to perform the second purge for 60 s; and the foregoing steps are repeated for 500 cycles to obtain the first coating layer and the second coating layer having a thickness ranging from 140 nm to 150 nm.

In the present disclosure, the base material layer may be commercially available, or may be prepared.

In an example, the base material layer is prepared, and a method for preparing the base material layer includes at least the following steps:
(B1) performing free radical treatment on the matrix; and
(B2) mixing the grafted monomer, an initiator, and a second solvent to form a mixed solution, and placing the treated matrix obtained in Step (B1) in the mixed solution to perform a graft reaction.

In the present disclosure, the method for preparing the base material layer may further include, before Step (B1), cleaning and drying the matrix. The cleaning may include a conventional cleaning method in the art, for example, soaking in a first solvent, draining, and repeating one time to five times. The first solvent may include a conventional solvent in the art, for example, anhydrous ethanol, and duration of the soaking may range from 50 s to 70 s. The drying may include a conventional drying method in the art, for example, drying in an oven at 30° C. to 60° C. for 1 hour to 10 hours.

In the present disclosure, in Step (B1), the free radical treatment may include conventional methods in the art, for example, generating a free radical by using electron beam radiation. A specific method is to place the matrix in a sealed manner in an inert atmosphere and generate a free radical from the matrix by using electron beam radiation.

In the present disclosure, in Step (B2), the initiator may include a conventional initiator in the art, for example, is 2,2′-Azobis(2-methylpropionitrile).

In the present disclosure, in Step (B2), the second solvent may include a conventional solvent in the art, for example, at least one of N,N,2-trimethylacrylamide, tetrahydrofuran, dimethyl sulfoxide, or isopropyl acetate.

In the present disclosure, in Step (B2), a condition of the mixing includes stirring at 50° C. to 80° C. (for example, is 50° C., 60° C., 70° C., or 80° C.) for 10 min to 60 min (for example, is 10 min, 20 min, 30 min, 40 min, 50 min, or 60 min).

In the present disclosure, in Step (B2), a condition of the graft reaction includes heating at 30° C. to 60° C. (for example, is 30° C., 40° C., 50° C., or 60° C.) for 18 hours to 30 hours (for example, is 18 hours, 19 hours, 20 hours, 21 hours, 22 hours, 23 hours, 24 hours, 25 hours, 26 hours, 27 hours, 28 hours, 29 hours, or 30 hours) in an inert atmosphere.

In the present disclosure, the inert atmosphere may include a conventional inert atmosphere in the art, for example, includes nitrogen.

In the present disclosure, the method for preparing the base material layer may further include, after Step (B2), taking out the matrix after the reaction, draining the matrix, airing the matrix to room temperature, cleaning the matrix with a third solvent, and drying the matrix. The third solvent may include a conventional solvent in the art, for example, is anhydrous ethanol. The cleaning may include a conventional cleaning method in the art, for example, ultrasonic cleaning. Duration of the cleaning ranges from 10 s to 60 s (for example, is 10 s, 20 s, 30 s, 40 s, 50 s, or 60 s), the cleaning may be repeated one time to five times (for example, is one time, two times, three times, four times, or five times), and the drying may include a conventional drying method in the art, for example, drying in an oven at 30° C. to 70° C. for 1 hour to 10 hours.

In the method described in the present disclosure, different precursors are selectively and alternately exposed on a surface of the base material layer, thereby forming a thin film on the surface of the base material layer. The separator prepared by using the method in the present disclosure has excellent step coverage and may generate an excellent three-dimensional conformal coating layer.

A third aspect of the present disclosure provides a battery. The battery includes the separator according to the first aspect of the present disclosure and/or the separator prepared by using the method according to the second aspect of the present disclosure.

In the present disclosure, components of the battery except the separator (such as a positive electrode plate, a negative electrode plate, and an electrolyte solution) may be conventional selections in the art.

In an example, the battery further includes a positive electrode plate, a negative electrode plate, and an electrolyte solution.

The positive electrode plate may include a positive electrode current collector and a positive electrode active material layer on a surface of at least one side of the positive electrode current collector. The positive electrode active material layer may include a positive electrode active material.

The positive electrode active material may be a conventional selection in the art. For example, the positive electrode active material includes at least one of lithium cobalt oxide, lithium nickel cobalt manganese oxide, lithium nickel cobalt aluminum oxide, lithium nickel cobalt manganese aluminum oxide, lithium manganese oxide, lithium nickel manganese oxide, lithium nickel oxide, lithium iron phosphate, lithium manganese iron phosphate, lithium vanadium phosphate, or a lithium-rich manganese-based material.

In the present disclosure, the positive electrode active material layer may further include a positive electrode binder and a positive electrode conductive agent.

The positive electrode binder may include a conventional binder in the art, for example, at least one of polyvinylidene fluoride (PVDF), sodium carboxymethyl cellulose, or styrene-butadiene rubber (SBR). The positive electrode conductive agent may include a conventional conductive agent in the art, for example, at least one of Super-P or activated carbon.

In the present disclosure, using a total weight of the positive electrode active material layer, a content of the positive electrode active material may range from 80 wt % to 99 wt % (for example, is 80 wt %, 85 wt %, 90 wt %, 95 wt %, or 99 wt %), a content of the positive electrode binder may range from 0.5 wt % to 10 wt % (for example, is 10 wt %, 7.5 wt %, 5 wt %, 2.5 wt %, or 0.5 wt %), and a content of the positive electrode conductive agent may range from 0.5 wt % to 10 wt % (for example, is 10 wt %, 7.5 wt %, 5 wt %, 2.5 wt %, or 0.5 wt %).

The negative electrode plate may include a negative electrode current collector and a negative electrode active material layer on a surface of at least one side of the negative electrode current collector. The negative electrode active material layer may include a negative electrode active material.

The negative electrode active material may be a conventional selection in the art. For example, the negative electrode active material includes at least one of graphite, graphene, mesocarbon microbead graphite, soft carbon, hard carbon, nano silicon, silicon oxide (SiOₓ, 0<x<2), silicon carbon (that is a material in which silicon particles are present on a surface of a porous carbon material and/or within pores of the porous carbon), or a silicon alloy.

In the present disclosure, the negative electrode active material layer may further include a negative electrode binder and a negative electrode conductive agent.

The negative electrode binder may include a conventional binder in the art, for example, at least one of PVDF, sodium carboxymethyl cellulose, carboxymethyl cellulose (CMC), or SBR.

The negative electrode conductive agent may include a conventional conductive agent in the art, for example, Super-P.

In the present disclosure, using a total weight of the negative electrode active material layer, a content of the negative electrode active material may range from 80 wt % to 99 wt % (for example, is 80 wt %, 85 wt %, 90 wt %, 95 wt %, or 99 wt %), a content of the negative electrode binder may range from 0.5 wt % to 10 wt % (for example, is 10 wt %, 7.5 wt %, 5 wt %, 2.5 wt %, or 0.5 wt %), and a content of the negative electrode conductive agent may range from 0.5 wt % to 10 wt % (for example, is 10 wt %, 7.5 wt %, 5 wt %, 2.5 wt %, or 0.5 wt %).

The electrolyte solution may be a conventional selection in the art. For example, the electrolyte solution includes an organic solvent and an electrolyte salt. The organic solvent is selected from, for example, at least one of ethylene carbonate (EC), ethyl methyl carbonate (EMC), vinylene carbonate, propylene carbonate (PC), butylene carbonate (BC), dimethyl fluorocarbonate, ethyl methyl fluorocarbonate, ethyl propyl carbonate (EPC), dimethyl carbonate (DMC), diethyl carbonate (DEC), dipropyl carbonate, or methyl propyl carbonate (MPC). The electrolyte salt is selected from, for example, at least one of lithium hexafluorophosphate (LiPF₆), lithium tetrafluoroborate (LiBF₄), lithium difluorophosphate (LiPF₂O₂), or lithium bis(fluorosulfonyl)imide (LiFSI).

In the present disclosure, a contact angle between the separator and the electrolyte solution may range from 10° to 60°, for example, is 10°, 15°, 20°, 25°, 30°, 35°, 40°, 45°, 50°, 55°, or 60°.

In the present disclosure, the contact angle between the separator and the electrolyte solution may be measured by the following method: The electrolyte solution is dropped onto a surface of the separator and the contact angle is measured by using a contact angle tester.

The battery may be assembled in a conventional manner in the art.

It should be noted that numerical expressions such as “first” and “second” in the present disclosure are only used to distinguish between different objects or usages, and do not represent a difference in order.

The following describes the present disclosure in detail by using embodiments. The embodiments described in the present disclosure are merely some, but not all of the embodiments of the present disclosure. All other embodiments obtained by a person of ordinary skill in the art based on the embodiments of the present disclosure without creative efforts fall within the protection scope of the present disclosure.

In the following examples, unless otherwise specified, all materials used were commercially available analytical reagents.

Example group I below was used to prepare a separator in the present disclosure.

### Example I1

The separator was prepared according to the following method.

(1) A polyethylene matrix (a thickness is 7 μm) was soaked in anhydrous ethanol for 70 s, taken out, and drained, these operations were repeated three times, and the matrix was dried in an oven at 45° C. for 3 hours.

(2) In a nitrogen atmosphere, the polyethylene matrix treated in Step (1) was flattened and placed in a seal bag, and a free radical was generated from the polyethylene matrix by using electron beam radiation.

(3) Methyl methacrylate, 2,2′-Azobis(2-methylpropionitrile), and N,N,2-trimethylacrylamide (where 2,2′-Azobis(2-methylpropionitrile) and N,N,2-trimethylacrylamide were mixed at a volume ratio of 1:1, and an amount of methyl methacrylate added is 5% of a total mass of methyl methacrylate, 2,2′-Azobis(2-methylpropionitrile), and N,N,2-trimethylacrylamide) were mixed, and the mixture was stirred at 70° C. for 30 min. The polyethylene matrix treated in Step (2) was placed in the mixed solution, nitrogen was introduced, and the mixture was heated at 50° C. for 24 hours to perform a graft reaction. The polyethylene matrix after the reaction was taken out, drained, and aired to room temperature, and ultrasonically cleaned with anhydrous ethanol for 30 s. These operations were repeated three times, and the matrix was dried in an oven at 45° C. for 3 hours.

(4) The polyethylene matrix obtained in Step (3) was placed on an atomic layer deposition instrument, and vacuuming and heating to 55° C. were performed; methyllithium was introduced and reacted for 40 s, and nitrogen was introduced to perform a purge for 20 s; a mixture of water vapor and CO₂ was introduced and reacted for 55 s, and nitrogen was introduced to perform a purge for 40 s; and the foregoing steps were repeated for 40 cycles.

### Example I2

The separator was prepared according to the following method.

(1) A polyethylene matrix (a thickness is 7 μm) was soaked in anhydrous ethanol for 60 s, taken out, and drained, these operations were repeated one time, and the matrix was dried in an oven at 30° C. for 10 hours.

(2) In a nitrogen atmosphere, the polyethylene matrix treated in Step (1) was flattened and placed in a seal bag, and a free radical was generated from the polyethylene matrix by using electron beam radiation.

(3) Methyl methacrylate, 2,2′-Azobis(2-methylpropionitrile), and N,N,2-trimethylacrylamide (where 2,2′-Azobis(2-methylpropionitrile) and N,N,2-trimethylacrylamide were mixed at a volume ratio of 1:1, and an amount of methyl methacrylate added is 12.5% of a total mass of methyl methacrylate, 2,2′-Azobis(2-methylpropionitrile), and N,N,2-trimethylacrylamide) were mixed, and the mixture was stirred at 50° C. for 60 min. The polyethylene matrix treated in Step (2) was placed in the mixed solution, nitrogen was introduced, and the mixture was heated at 30° C. for 30 hours to perform a graft reaction. The polyethylene matrix after the reaction was taken out, drained, and aired to room temperature, and ultrasonically cleaned with anhydrous ethanol for 10 s. These operations were repeated five times, and the matrix was dried in an oven at 30° C. for 7 hours.

(4) The polyethylene matrix obtained in Step (3) was placed on an atomic layer deposition instrument, and vacuuming and heating to 55° C. were performed; methyllithium was introduced and reacted for 40 s, and nitrogen was introduced to perform a purge for 20 s; a mixture of water vapor and CO₂ was introduced and reacted for 55 s, and nitrogen was introduced to perform a purge for 40 s; and the foregoing steps were repeated for 80 cycles.

### Example I3

The separator was prepared according to the following method.

(1) A polyethylene matrix (a thickness is 7 μm) was soaked in anhydrous ethanol for 50 s, taken out, and drained, these operations were repeated five times, and the matrix was dried in an oven at 60° C. for 2 hours.

(2) In a nitrogen atmosphere, the polyethylene matrix treated in Step (1) was flattened and placed in a seal bag, and a free radical was generated from the polyethylene matrix by using electron beam radiation.

(3) Methyl methacrylate, 2,2′-Azobis(2-methylpropionitrile), and N,N,2-trimethylacrylamide (where 2,2′-Azobis(2-methylpropionitrile) and N,N,2-trimethylacrylamide were mixed at a volume ratio of 1:1, and an amount of methyl methacrylate added is 20% of a total mass of methyl methacrylate, 2,2′-Azobis(2-methylpropionitrile), and N,N,2-trimethylacrylamide) were mixed, and the mixture was stirred at 80° C. for 10 min. The polyethylene matrix treated in Step (2) was placed in the mixed solution, nitrogen was introduced, and the mixture was heated at 60° C. for 18 hours to perform a graft reaction. The polyethylene matrix after the reaction was taken out, drained, and aired to room temperature, and ultrasonically cleaned with anhydrous ethanol for 60 s. These operations were repeated one time, and the matrix was dried in an oven at 75° C. for 1 hour.

(4) The polyethylene matrix obtained in Step (3) was placed on an atomic layer deposition instrument, and vacuuming and heating to 55° C. were performed; methyllithium was introduced and reacted for 40 s, and nitrogen was introduced to perform a purge for 20 s; a mixture of water vapor and CO₂ was introduced and reacted for 55 s, and nitrogen was introduced to perform a purge for 40 s; and the foregoing steps were repeated for 20 cycles.

### Example I4

For this example, reference is made to Example I1. A difference lies in that the quantity of repetition cycles in Step (4) was changed. Details are as follows.

In Example I4a, 40 repetition cycles was changed to 2 repetition cycles.

In Example I4b, 40 repetition cycles was changed to 10 repetition cycles.

In Example I4c, 40 repetition cycles was changed to 100 repetition cycles.

In Example I4d, 40 repetition cycles was changed to 200 repetition cycles.

### Example I5

For this example, reference is made to Example I1. A difference lies in that a type of the matrix in Step (1) was changed and the quantity of repetition cycles in Step (4) was changed to maintain a ratio of a thickness of a first coating layer to a pore diameter of a pore at about 1:20. Details are as follows.

In Example I5a, the polyethylene matrix (a thickness is 7 μm) was replaced with a polypropylene matrix (a thickness is 12 μm).

In Example I5b, the polyethylene matrix (a thickness is 7 μm) is replaced with a glass fiber matrix (a thickness is 15 μm).

In Example I5c, the polyethylene matrix (a thickness is 7 km) is replaced with a polypropylene-polyethylene-polypropylene composite three-layer separator matrix (a thickness is 12 km).

### Example I6

For this example, reference is made to Example I1. A difference lies in that a type of a monomer for the graft copolymerization modification in Step (3) was changed. Details are as follows.

In Example I6a, methyl methacrylate was replaced with methyl acrylate having an equal mass.

In Example I6b, methyl methacrylate was replaced with butyl methacrylate having an equal mass.

### Example I7

For this example, reference is made to Example I1. A difference lies in that an added amount of a monomer for the graft copolymerization modification in Step (3) was changed. Details are as follows.

In Example I7a, methyl methacrylate, 2,2′-Azobis(2-methylpropionitrile), and N,N,2-trimethylacrylamide (where 2,2′-Azobis(2-methylpropionitrile) and N,N,2-trimethylacrylamide were mixed at a volume ratio of 1:1, and an amount of methyl methacrylate added is 1.25% of a total mass of methyl methacrylate, 2,2′-Azobis(2-methylpropionitrile), and N,N,2-trimethylacrylamide) were mixed.

In Example I7b, methyl methacrylate, 2,2′-Azobis(2-methylpropionitrile), and N,N,2-trimethylacrylamide (where 2,2′-Azobis(2-methylpropionitrile) and N,N,2-trimethylacrylamide were mixed at a volume ratio of 1:1, and an amount of methyl methacrylate added is 25% of a total mass of methyl methacrylate, 2,2′-Azobis(2-methylpropionitrile), and N,N,2-trimethylacrylamide) were mixed.

### Example I8

For this example, reference is made to Example I1. A difference lies in that a type of the precursors, duration of the reactions, and duration of the purges in Step (4) were changed. Details are as follows.

In Example I8a, the polyethylene matrix obtained in Step (3) was placed on an atomic layer deposition instrument, and vacuuming and heating to 55° C. were performed; methyllithium was introduced and reacted for 40 s, and nitrogen was introduced to perform a purge for 20 s; a mixture of gases HCl and N₂ was introduced and reacted for 55 s, and nitrogen was introduced to perform a purge for 40 s; and the foregoing steps were repeated for 40 cycles.

In Example I8b, the polyethylene matrix obtained in Step (3) was placed on an atomic layer deposition instrument, and vacuuming and heating to 60° C. were performed; methyllithium was introduced and reacted for 40 s, and nitrogen was introduced to perform a purge for 20 s; a mixture of gases HF and N₂ was introduced and reacted for 50 s, and nitrogen was introduced to perform a purge for 40 s; a mixture of gases PF₅ and N₂ was introduced and reacted for 60 s, and nitrogen was introduced to perform a purge for 45 s; and the foregoing steps were repeated for 40 cycles.

In Example I8c, the polyethylene matrix obtained in Step (3) was placed on an atomic layer deposition instrument, and vacuuming and heating to 55° C. were performed. Methyllithium was introduced and reacted for 40 s, and nitrogen was introduced to perform a purge for 20 s; a mixture of water vapor and CO₂ was introduced and reacted for 55 s, and nitrogen was introduced to perform a purge for 40 s; and the foregoing steps were repeated for 28 cycles. Methyllithium was introduced and reacted for 40 s, and nitrogen was introduced to perform a purge for 20 s; a mixture of gases HCl and N₂ was introduced and reacted for 55 s, and nitrogen was introduced to perform a purge for 40 s; and the foregoing steps were repeated for 12 cycles.

Specific parameters in Examples I1 to I8 are shown in Table 1-1 and Table 1-2. In all the examples, a second coating layer is located on surfaces of both sides of the base material layer, a porosity of a base material layer ranges from 10% to 60%, an ionic conductivity of the separator ranges from 1 S/cm to 30 S/cm, and a contact angle between the separator and an electrolyte solution ranges from 10° to 60°.

TABLE 1-1

| | | | Ratio of the | | |
|---|---|---|---|---|---|
| | Thickness of | Pore | thickness of the first | | |
| | the first | diameter | coating layer to the | | Thickness of |
| | coating layer | of the | pore diameter of the | Lithium-containing | the separator |
| | (nm) | pores (nm) | pores | compound | (μm) |
| Example I1 | 2 | 38.42 | 1:20 | Lithium carbonate | 7.4 |
| Example I2 | 4 | 39.53 | 1:10 | Lithium carbonate | 7.3 |
| Example I3 | 1 | 40.03 | 1:40 | Lithium carbonate | 7.12 |
| Example I4a | 0.1 | 40.40 | 1:400 | Lithium carbonate | 7 |
| Example I4b | 0.5 | 40.24 | 1:80 | Lithium carbonate | 7.1 |
| Example I4c | 5 | 38.42 | 1:8 | Lithium carbonate | 7.4 |
| Example I4d | 10 | 40.53 | 1:4 | Lithium carbonate | 7.7 |
| Example I5a | 3 | 59.62 | 1:20 | Lithium carbonate | 12.7 |
| Example I5b | 3 | 61.15 | 1:20 | Lithium carbonate | 15.1 |
| Example I5c | 3 | 59.75 | 1:20 | Lithium carbonate | 12.3 |
| Example I6a | 2 | 40.77 | 1:20 | Lithium carbonate | 7.3 |
| Example I6b | 2 | 37.96 | 1:20 | Lithium carbonate | 7.1 |
| Example I7a | 2 | 39.92 | 1:20 | Lithium carbonate | 7.4 |
| Example I7b | 2 | 38.58 | 1:20 | Lithium carbonate | 7 |
| Example I8a | 2 | 40.66 | 1:20 | Lithium chloride | 7.2 |
| Example I8b | 2 | 38.92 | 1:20 | Lithium | 7.4 |
| | | | | hexafluorophosphate | |
| Example I8c | 2 | 40.23 | 1:20 | Lithium carbonate + | 7.4 |
| | | | | lithium chloride (a | |
| | | | | mass ratio of lithium | |
| | | | | carbonate to lithium | |
| | | | | chloride was 7:3) | |

TABLE 1-2

| | Base material layer | | |
|---|---|---|---|
| | | | Percentage of a mass of the |
| | | Monomer for the graft | monomer grafted onto the matrix |
| | | copolymerization | in a total mass of the base material |
| | Matrix | modification | layer (%) |
| Example I1 | Polyethylene | Methyl methacrylate | 2 |
| Example I2 | Polyethylene | Methyl methacrylate | 5 |
| Example I3 | Polyethylene | Methyl methacrylate | 8 |
| Example I4a | Polyethylene | Methyl methacrylate | 2 |
| Example I4b | Polyethylene | Methyl methacrylate | 2 |
| Example I4c | Polyethylene | Methyl methacrylate | 2 |
| Example I4d | Polyethylene | Methyl methacrylate | 2 |
| Example I5a | Polypropylene | Methyl methacrylate | 2 |
| Example I5b | Glass fiber | Methyl methacrylate | 2 |
| Example I5c | Polypropylene and | Methyl methacrylate | 2 |
| | polyethylene | | |
| | composite three- | | |
| | layer separator | | |
| Example I6a | Polyethylene | Methyl acrylate | 2 |
| Example I6b | Polyethylene | Butyl methacrylate | 2 |
| Example I7a | Polyethylene | Methyl methacrylate | 0.5 |
| Example I7b | Polyethylene | Methyl methacrylate | 10 |
| Example I8a | Polyethylene | Methyl methacrylate | 2 |
| Example I8b | Polyethylene | Methyl methacrylate | 2 |
| Example I8c | Polyethylene | Methyl methacrylate | 2 |

Note: In Examples I1 to I8, a thickness of the second coating layer is equal to a thickness of the first coating layer; and a first lithium-containing compound and a second lithium-containing compound are the same, and each are the lithium-containing compound in Table 1-1.

### Comparative Example D1

A polyethylene matrix having a thickness of 7 μm was selected.

### Comparative Example D2

A polyethylene matrix having a thickness of 7 μm was selected, and a coating layer having a thickness of 3 μm (including aluminum oxide and PVDF, where a mass ratio of aluminum oxide to PVDF was 85:15) was applied on both sides of the matrix.

### Comparative Example D3

For this example, reference is made to Example I1. A difference lies in that in Step (4), a coating layer having a thickness of 3 μm (including aluminum oxide and PVDF, where a mass ratio of aluminum oxide to PVDF was 85:15) was applied on both sides of the modified polyethylene matrix obtained in Step (3).

### Comparative Example D4

For this example, reference is made to Example I1. A difference lies in that in Step (1), the matrix was replaced with PET nonwoven fabric (the pore diameter of the pore is 600 nm), where a ratio of the thickness of the first coating layer to the pore diameter of the pore was 1:600, and the thickness of the separator was 15.44 μm.

### Comparative Example D5

For this example, reference is made to Example I1. A difference lies in that in Step (1), the matrix was replaced with a polyethylene matrix (a thickness is 7 μm) having a pore diameter of the pore of 24.00 nm; and in Step (4), the quantity of cycles was changed from 20 to 80, the thickness of the first coating layer was 8 nm, the ratio of the thickness of the first coating layer to the pore diameter of the pore was 1:3, and the thickness of the separator was 7.21 μm.

Example group II below was used to prepare a battery in the present disclosure.

### Example II1

The battery was prepared according to the following method.

### (1) Preparation of a Positive Electrode Plate.

Lithium cobalt oxide, a mixed conductive agent, (Super-P and activated carbon at a mass ratio of 1:1) and PVDF were dissolved at a mass ratio of 97.5:1.35:1.15 in N-methylpyrrolidone, and a mixture was stirred evenly to prepare a positive electrode slurry. The positive electrode slurry was evenly applied on two surfaces of aluminum foil, the aluminum foil was dried, cold pressed, and slit, and tabs were welded to obtain the positive electrode plate.

### (2) Preparation of a Negative Electrode Plate.

Graphite, Super-P, CMC, and SBR were dissolved in deionized water at a mass ratio of 97.1:0.6:1.0:1.3, and a mixture was stirred evenly to prepare a negative electrode slurry. The negative electrode slurry was evenly applied on two surfaces of copper foil, the copper foil was dried, cold pressed, and slit, and tabs were welded to obtain the negative electrode plate.

### (3) Preparation of an Electrolyte Solution.

LiPF₆ and an organic solvent (Mass ratio of ethylene carbonate:diethyl carbonate:ethyl methyl carbonate:vinylene carbonate=8:85:5:2) were mixed at a mass ratio of 8:92.

### (4) Preparation of a Battery.

The separator prepared in Example I1, the positive electrode plate prepared in Step (1), and the negative electrode plate prepared in Step (2) were wound and assembled into a battery cell, and the battery cell was then dried, injected with an electrolyte solution, and packaged.

### Test Example

### (1) SEM Test

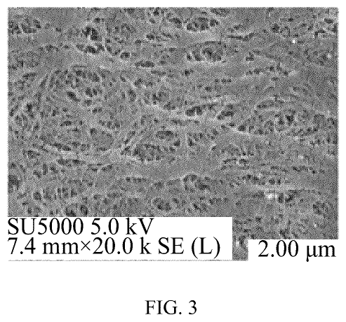

A SEM scanning test was performed on the separator prepared in Example 1. FIG. 2 is a SEM image of a cross section of a separator prepared in Example 1 before deposition of a first coating layer and a second coating layer. FIG. 3 is a SEM image of a cross section of a separator prepared in Example 1 after deposition of a first coating layer and a second coating layer. Through comparison between FIG. 2 and FIG. 3, it may be learned that after the deposition of the first coating layer and the second coating layer, ion conduction pores are not blocked, and original pores of the separator are well preserved.

### (2) Rate Performance Test

Rate performance tests were performed on batteries prepared in the examples and comparative examples, and specific test methods were as follows:
1—standing at 25° C.±2° C. for 10 min;
2—discharging at 0.2 C to 3.0 V;
3—standing for 10 min;
4—charging at 0.7 C to 4.4 V in a constant temperature room, with a cut-off current of 0.025 C;
5—standing for 10 min;
6—discharging at a specific rate (the rate is as follows) to a lower limit voltage of 3.0 V in a constant temperature room or a thermostat environment; and
7—standing for 10 min.

1 to 7 were repeated until all-rate discharge tests were completed, where a discharge rate was 0.2 C/1 C/2 C/5 C/7 C, and test results were recorded in Table 2. (Capacity sizing was performed at a discharge capacity of 0.2 C. Capacity retention rate at another discharge rate=discharge capacity/discharge capacity of 0.2 C)

### (3) Impedance Test

Impedance tests were performed on batteries prepared in the examples and comparative examples, and specific test methods were as follows.

For electrochemical workstations, constant voltage modes, and a scanning frequency range of 10 kHz to 70 mHz, 10 points were taken at each frequency, and test results were recorded in Table 2.

TABLE 2

| | | | | | | | 100% SOC |
|---|---|---|---|---|---|---|---|
| | | Capacity retention rate (%) | | | | | impedance |
| | Separator | 0.2 C | 1 C | 2 C | 5 C | 7 C | (mΩ) |
| Example II1 | Example I1 | 100 | 99.87 | 99.64 | 95.53 | 91.86 | 23.48 |
| Example II2 | Example I2 | 100 | 99.90 | 99.56 | 95.55 | 91.90 | 23.57 |
| Example II3 | Example I3 | 100 | 99.83 | 99.51 | 95.55 | 91.75 | 23.55 |
| Example | Example I4a | 100 | 99.62 | 99.10 | 95.04 | 90.89 | 24.33 |
| II4a | | | | | | | |
| Example | Example I4b | 100 | 99.71 | 99.21 | 95.14 | 91.21 | 24.02 |
| II4b | | | | | | | |
| Example | Example I4c | 100 | 99.69 | 99.24 | 95.16 | 91.32 | 23.99 |
| II4c | | | | | | | |
| Example | Example I4d | 100 | 99.58 | 99.02 | 95.13 | 90.67 | 24.65 |
| II4d | | | | | | | |
| Example | Example I5a | 100 | 99.81 | 99.51 | 95.47 | 91.73 | 25.12 |
| II5a | | | | | | | |
| Example | Example I5b | 100 | 99.81 | 99.24 | 95.42 | 91.46 | 25.37 |
| II5b | | | | | | | |
| Example | Example I5c | 100 | 99.79 | 99.31 | 95.26 | 91.66 | 25.23 |
| II5c | | | | | | | |
| Example | Example I6a | 100 | 99.86 | 99.51 | 95.42 | 91.66 | 23.73 |
| II6a | | | | | | | |
| Example | Example I6b | 100 | 99.82 | 99.63 | 95.49 | 91.53 | 23.82 |
| II6b | | | | | | | |
| Example | Example I7a | 100 | 99.53 | 99.26 | 95.32 | 91.44 | 23.89 |
| II7a | | | | | | | |
| Example | Example I7b | 100 | 99.64 | 99.32 | 95.18 | 92.23 | 24.01 |
| II7b | | | | | | | |
| Example | Example I8a | 100 | 99.62 | 99.37 | 95.37 | 91.48 | 23.90 |
| II8a | | | | | | | |
| Example | Example I8b | 100 | 99.62 | 99.31 | 95.33 | 91.43 | 23.94 |
| II8b | | | | | | | |
| Example | Example I8c | 100 | 99.63 | 99.44 | 95.42 | 91.66 | 23.86 |
| II8c | | | | | | | |
| Comparative | Comparative | 100 | 98.06 | 95.34 | 90.14 | 86.32 | 27.67 |
| Example | Example D1 | | | | | | |
| DD1 | | | | | | | |
| Comparative | Comparative | 100 | 98.15 | 95.35 | 91.74 | 86.75 | 28.22 |
| Example | Example D2 | | | | | | |
| DD2 | | | | | | | |
| Comparative | Comparative | 100 | 98.31 | 95.87 | 90.33 | 87.33 | 27.34 |
| Example | Example D3 | | | | | | |
| DD3 | | | | | | | |
| Comparative | Comparative | 100 | 98.78 | 95.78 | 91.64 | 88.65 | 26.67 |
| Example | Example D4 | | | | | | |
| DD4 | | | | | | | |
| Comparative | Comparative | 100 | 98.32 | 95.88 | 91.90 | 88.60 | 27.64 |
| Example | Example D5 | | | | | | |
| DD5 | | | | | | | |

It may be learned from Table 2 that the battery prepared with the separator in the present disclosure has improved rate performance and a reduced impedance compared with the comparative examples.

The foregoing describes in detail a preferred implementation of the present disclosure. However, the present disclosure is not limited thereto. Within the scope of the technical concepts of the present disclosure, various simple variations may be implemented to the technical solutions of the present disclosure, including combinations of technical features in any other suitable manner. These simple variations and combinations shall also be considered as the disclosure of the present disclosure and shall fall within the protection scope of the present disclosure.

What is claimed is:

1. A separator, comprising a base material layer and a first coating layer, wherein the base material layer has a porous structure, the porous structure has pores, the first coating layer is located on inner walls of the pores, the first coating layer comprises a first lithium-containing compound, and a ratio of a thickness of the first coating layer to a pore diameter of the pores ranges from 1:4 to 1:500.

2. The separator according to claim 1, wherein the ratio of the thickness of the first coating layer to the pore diameter of the pores ranges from 1:8 to 1:400; and/or
the pore diameter of the pores ranges from 10 nm to 1000 nm; and/or
the thickness of the first coating layer ranges from 0.01 nm to 200 nm.

3. The separator according to claim 2, wherein the ratio of the thickness of the first coating layer to the pore diameter of the pores ranges from 1:10 to 1:40; and/or
the pore diameter of the pores ranges from 20 nm to 85 nm; and/or
the thickness of the first coating layer ranges from 0.05 nm to 10 nm.

4. The separator according to claim 2, wherein the thickness of the first coating layer ranges from 1 nm to 4 nm.

5. The separator according to claim 1, wherein the separator further comprises a second coating layer, the second coating layer is located on a surface of either or both sides of the base material layer, and the second coating layer comprises a second lithium-containing compound; and/or
the first coating layer and the second coating layer are obtained by using an atomic layer deposition technology; and/or
the first coating layer and the second coating layer are disposed in contact with each other.

6. The separator according to claim 5, wherein a thickness of the second coating layer is equal to the thickness of the first coating layer; or
the thickness of the second coating layer is greater than the thickness of the first coating layer; or
the thickness of the second coating layer is less than the thickness of the first coating layer.

7. The separator according to claim 1, wherein the base material layer comprises a modified matrix or an unmodified matrix, and the modified matrix and the unmodified matrix comprise at least one of polyethylene, polyvinyl chloride, polyoxyethylene, polypropylene, nylon, glass fiber, polyethylene terephthalate, polyimide, aramid, cellulose, or nonwoven fabric.

8. The separator according to claim 7, wherein a modification of the modified matrix comprises graft copolymerization.

9. The separator according to claim 8, wherein a monomer for the graft copolymerization comprises an ester.

10. The separator according to claim 8, wherein a monomer for the graft copolymerization comprises at least one of methyl methacrylate, methyl acrylate, propyl methacrylate, or glycerol methacrylate.

11. The separator according to claim 7, wherein the base material layer comprises the modified matrix modified by graft copolymerization, and a mass of a monomer grafted onto the modified matrix accounts for 0.1% to 20% of a total mass of the base material layer.

12. The separator according to claim 11, wherein the mass of the monomer grafted onto the matrix accounts for 2% to 8% of the total mass of the base material layer; and/or
the base material layer comprises polyethylene modified by graft copolymerization of methyl methacrylate.

13. The separator according to claim 1, wherein a porosity of the base material layer ranges from 10% to 60%; and/or
an ionic conductivity of the separator ranges from 1 S/cm to 40 S/cm; and/or
a thickness of the separator ranges from 3 μm to 16 μm.

14. The separator according to claim 13, wherein the ionic conductivity of the separator ranges from 1 S/cm to 30 S/cm; and/or
the thickness of the separator ranges from 5 μm to 9 μm.

15. The separator according to claim 5, wherein the first lithium-containing compound and the second lithium-containing compound each independently comprise a lithium salt, and the lithium salt comprises at least one of lithium carbonate, lithium halide, lithium hexafluorophosphate, or lithium borate.

16. The separator according to claim 5, wherein the first lithium-containing compound and the second lithium-containing compound comprise at least lithium carbonate.

17. The separator according to claim 16, wherein a mass percentage of lithium carbonate in the first lithium-containing compound ranges from 40% to 100%; and/or
a mass percentage of lithium carbonate in the second lithium-containing compound ranges from 40% to 100%.

18. A method for preparing the separator according to claim 1, wherein the method comprises at least following steps:
(A1) introducing a first precursor into a base material layer at a first heating temperature to perform a first reaction, and introducing a first inert atmosphere to perform a first purge;
(A2) introducing a second precursor at a second heating temperature to perform a second reaction, and introducing a second inert atmosphere to perform a second purge;
optionally, (A3) introducing a third precursor at a third heating temperature to perform a third reaction, and introducing a third inert atmosphere to perform a third purge; and
(A4) repeating the foregoing steps (A1) and (A2) or (A1) to (A3) 1 time to 500 times, wherein the base material layer comprises a modified matrix or an unmodified matrix, and the modified matrix and the unmodified matrix comprise at least one of polyethylene, polyvinyl chloride, polyoxyethylene, polypropylene, nylon, glass fiber, polyethylene terephthalate, polyimide, aramid, cellulose, or nonwoven fabric; the first precursor comprises at least one of methyllithium, n-butyllithium, tert-butyllithium, lithium tert-butoxide, phenyllithium, or dialkyl copper lithium; the second precursor comprises at least one of following gases: water vapor, CO₂, HF, HCl, HBr, HI, N₂, or O₂; and the third precursor comprises at least one of the following gases: PF₅, N₂, trimethylboron, O₂, or O₃.

19. A battery, comprising the separator according to claim 1.

20. The battery according to claim 19, wherein the battery further comprises an electrolyte solution, and a contact angle between the separator and the electrolyte solution ranges from 10° to 60°.
